(19) United States
(12) Patent Application Publication
(10) Pub. No.: US 2025/0030831 A1
(43) Pub. Date: Jan. 23, 2025

(54) DRIVING METHOD AND DEVICE FOR DISPLAY DEVICE, AND DISPLAY APPARATUS

(71) Applicant: BEIJING SHIYAN TECHNOLOGY CO., LTD., Beijing (CN)

(72) Inventors: Yan Sun, Beijing (CN); Minglei Chu, Beijing (CN); Shuo Zhang, Beijing (CN); Qiong Wu, Beijing (CN); Tiankuo Shi, Beijing (CN); Xin Duan, Beijing (CN); Wei Sun, Beijing (CN)

(73) Assignee: BEIJING SHIYAN TECHNOLOGY CO., LTD., Beijing (CN)

(21) Appl. No.: 18/714,672

(22) PCT Filed: May 6, 2023
(86) PCT No.: PCT/CN2023/092510

§ 371 Date: May 30, 2024

(30) Foreign Application Priority Data
May 31, 2022 (CN) 202210609363.X

(51) Int. Cl. H04N 13/398; H04N 13/00; H04N 13/128; H04N 13/305

(52) U.S. Cl. CPC H04N 13/398; H04N 13/128; H04N 13/305; H04N 2013/0081; H04N 2013/0096

(57) ABSTRACT

A driving method for a display device, including: inputting a source image, wherein the source image includes depth information; searching in the source image by utilizing the depth information to determine first image pixel points matched with light-emitting sub-pixels of the display device; assigning pixel gray values of the first image pixel points to the light-emitting sub-pixels of the display device; and controlling the light-emitting sub-pixels to emit light according to assigned pixel gray values, so that the display device displays a multi-viewpoint image corresponding to the source image. The driving method of the display device provided in the embodiment of the present application directly searches for the first image pixel that satisfies the preset parallax condition on the source image based on the depth information, renders the display device, saves hardware storage resources, and improves the processing efficiency of multi-viewpoint naked-eye 3D display.

### CROSS-REFERENCE TO RELATED APPLICATION

This application claims the priority of the Chinese patent application filed on May 31, 2022 before the CNIPA, China National Intellectual Property Administration with the application number of 202210609363.X and the title of “DRIVING METHOD AND DEVICE FOR DISPLAY DEVICE, AND DISPLAY APPARATUS”, which is incorporated herein in its entirety by reference.

### FIELD

The present application relates to the technical field of display equipment, and more particularly relates to a driving method for a display device, a driving device for a display device, and a display apparatus.

### BACKGROUND

A current naked-eye 3D display apparatus may simulate multi-viewpoint picture signals received by human eyes in daily life. Specifically, through multi-viewpoint picture display, an observer in a correct visual area is allowed to receive images from multiple viewpoint directions through human eyes simultaneously, and then the observer processes the multi-viewpoint picture signals through brain, so that the observer perceives the stereoscopic sense of pictures.

### SUMMARY

An embodiment of the present application provides a driving method for a display device, including:
inputting a source image, wherein the source image comprises depth information;
searching in the source image by utilizing the depth information to determine first image pixel points matched with light-emitting sub-pixels of the display device;
assigning pixel gray values of the first image pixel points to the light-emitting sub-pixels of the display device; and
controlling the light-emitting sub-pixels to emit light according to assigned pixel gray values, so that the display device displays a multi-viewpoint image corresponding to the source image.

Optionally, the step of searching in the source image by utilizing the depth information to determine first image pixel points matched with light-emitting sub-pixels of the display device comprises:
searching in the source image according to viewpoint numbers of the light-emitting sub-pixels and the depth information to determine the first image pixel point matched with each of the light-emitting sub-pixels;
wherein the viewpoint numbers are preset according to a quantity of viewpoints to be rendered, pixel coordinates of the light-emitting sub-pixels, and apparatus parameters of the display device.

Optionally, the step of searching in the source image according to viewpoint numbers of the light-emitting sub-pixels and the depth information to determine the first image pixel point matched with each of the light-emitting sub-pixels comprises:
obtaining a parallax of second image pixel points corresponding to current light-emitting sub-pixels in the source image according to the viewpoint numbers of the current light-emitting sub-pixels; wherein the pixel coordinates of the current light-emitting sub-pixels and pixel coordinates of the second image pixel points are mapped on a one-to-one basis; and
searching in a preset parallax range in the source image according to the parallax of the second image pixel points to determine first image pixel points matched with the current light-emitting sub-pixels.

Optionally, the step of obtaining a parallax of second image pixel points corresponding to current light-emitting sub-pixels in the source image according to the viewpoint numbers of the current light-emitting sub-pixels comprises:
obtaining an actual shooting distance of the second image pixel points according to depth information of the second image pixel points; and
obtaining the parallax of the second image pixel points according to the viewpoint numbers of the current light-emitting sub-pixels and the actual shooting distance of the second image pixel points.

Optionally, the depth information comprises a depth image; wherein image pixel points in the depth image and depth image pixel points in the source image are mapped on a one-to-one basis; and pixel gray values of the depth image pixel points mapped by the second image pixel points in the depth image are used for representing depth information of the second image pixel points; and
the step of obtaining an actual shooting distance of the second image pixel points according to depth information of the second image pixel points comprises:
obtaining the actual shooting distance of the second image pixel points according to the pixel gray values of the depth image pixel points mapped by the second image pixel points in the depth image in a linear conversion manner and/or non-linear conversion manner.

Optionally, the step of obtaining the parallax of the second image pixel points according to the viewpoint numbers of the current light-emitting sub-pixels and the actual shooting distance of the second image pixel points comprises:
obtaining a baseline width according to the quantity of the viewpoints to be rendered and the viewpoint numbers of the current light-emitting sub-pixels;
obtaining the parallax of the second image pixel points according to the baseline width, a shooting focal length of the source image, and a distance parameter difference value between the second image pixel points and a zero parallax plane;
wherein the distance parameter difference value between the second image pixel points and the zero parallax plane is obtained according to the actual shooting distance of the second image pixel points and an actual distance of the zero parallax plane.

Optionally, the step of searching in a preset parallax range in the source image according to the parallax of the second image pixel points to determine first image pixel points matched with the current light-emitting sub-pixels comprises:
traversing and searching the first image pixel points in the source image in the preset parallax range based on the second image pixel points;
wherein in the case where a parallax position of current image pixel points satisfies a preset parallax condition, it is determined that the current image pixel points are the first image pixel points:

wherein the preset parallax range comprises: traversing a position range of a preset quantity of image pixel points along an image pixel line where the second image pixel points are located based on a position of the second image pixel points.

Optionally, the preset parallax condition comprises:
a sum of a pixel coordinate difference between the current image pixel points and the second image pixel points and the parallax of the second image pixel points being less than 1; and
wherein the pixel coordinate difference between the current image pixel points and the second image pixel points comprises: a difference between a column pixel coordinate of the current image pixel points and a column pixel coordinate of the second image pixel points.

Optionally, the method further comprises:
after traversing and searching all the image pixel points in the preset parallax range, under the condition that there is no image pixel point satisfying the preset parallax condition, determining that the current light-emitting sub-pixels are voids;
after determining that the current light-emitting sub-pixels are voids, obtaining a pixel gray value of an image pixel point with a minimum depth in the preset parallax range based on the second image pixel points; and
assigning the pixel gray value of the image pixel point with the minimum depth to the current light-emitting sub-pixels.

Optionally, the display device comprises: an image splitting device and a display panel; the image splitting device comprises at least one grating unit, wherein light-emitting sub-pixels corresponding to same positions of different grating units have same viewpoint numbers; and
the apparatus parameters of the display device comprise: a length of the light-emitting sub-pixels, a width of the light-emitting sub-pixels, a fitting angle of the image splitting device, a width of the grating unit, and a pixel resolution of the display panel.

Optionally, before the step of searching in the source image by utilizing the depth information to determine first image pixel points matched with light-emitting sub-pixels of the display device, the method further comprises:
obtaining a quantity of viewpoint sub-pixels of each light-emitting sub-pixel line according to the width of the grating unit of the image splitting device, the length of the light-emitting sub-pixels, and the fitting angle of the image splitting device;
obtaining an offset quantity of two adjacent lines of light-emitting sub-pixels according to the length of the light-emitting sub-pixels, the width of the light-emitting sub-pixels, and the fitting angle of the image splitting device; and
obtaining the viewpoint number of any one of the light-emitting sub-pixels in the display device according to the quantity of the viewpoint sub-pixels of each light-emitting sub-pixel line, and the offset quantity of the two adjacent lines of the light-emitting sub-pixels.

Optionally, the step of obtaining the viewpoint number of any one of the light-emitting sub-pixels in the display device according to the quantity of the viewpoint sub-pixels of each light-emitting sub-pixel line, and the offset quantity of the two adjacent lines of the light-emitting sub-pixels comprises:
obtaining a quantity of viewpoints corresponding to a horizontal unit light-emitting sub-pixel length according to the quantity of the viewpoint sub-pixels of each light-emitting sub-pixel line, and the quantity of the viewpoints to be rendered;
obtaining a quantity of viewpoints corresponding to a longitudinal unit light-emitting sub-pixel length according to the offset quantity of the two adjacent lines of the light-emitting sub-pixels, and the quantity of the viewpoints corresponding to the horizontal unit light-emitting sub-pixel length;
determining a viewpoint number to which a first light-emitting sub-pixel of each line belongs according to a first calculated viewpoint number of the light-emitting sub-pixel and a horizontal resolution of the display panel, and
obtaining a viewpoint number of any one of the light-emitting sub-pixels in the display device according to the viewpoint number to which the first light-emitting sub-pixel of each line belongs, and a longitudinal resolution of the display panel.

Optionally, before the step of searching in the source image by utilizing the depth information to determine first image pixel points matched with light-emitting sub-pixels of the display device, the method further comprises:
obtaining an original image; and
initializing the original image to enable a horizontal resolution and/or longitudinal pixel resolution of the original image to be consistent with that of the display device to obtain the source image.

Optionally, a calculation formula of the parallax of the second image pixel points is as follows:

$$B = int ( \frac{V}{2} ) + 1 - {V}_{i , j} , Dis ( i , j ) = F * B * ( \frac{1}{Z ( i , j )} - \frac{1}{{Z}_{zero}} )$$

wherein V_{i,j} is the viewpoint numbers of the current light-emitting sub-pixels, V is the quantity of the viewpoints to be rendered, Dis(i,j) is the parallax of the second image pixel points, Z(i,j) is the actual shooting distance of the second image pixel points, F is the shooting focal length of the source image, B is the baseline width, and Z_{zero} is a zero parallax distance;
wherein the zero parallax distance is a distance between the zero parallax plane and a shooting lens, and the zero parallax plane refers to a plane coinciding with a naked-eye 3D screen after a three-dimensional scene is reconstructed.

Optionally, a calculation formula for obtaining the actual shooting distance of the second image pixel points according to the pixel gray values of the depth image pixel points mapped by the second image pixel points in the depth image in a linear conversion manner is as follows:

$$Z ( i , j ) = {Z}_{near} - {Z}_{far} ) * \frac{D ( i , j )}{255} + {Z}_{far}$$

wherein Z_{far} is a farthest actual shooting distance, Zₙₑₐᵣ is a nearest actual shooting distance, and D(i,j) is a pixel gray value of the second image pixel points corresponding to the current light-emitting sub-pixels in the source image on the depth image;

wherein the nearest actual shooting distance is a distance between the shooting lens and a position on a target object nearest the shooting lens, and the farthest actual shooting distance is a distance between the shooting lens and a position on the target object farthest from the shooting lens.

Optionally, a calculation formula for obtaining the actual shooting distance of the second image pixel points according to the pixel gray values of the depth image pixel points mapped by the second image pixel points in the depth image in a non-linear conversion manner is as follows:

$$Z ( i , j ) = \frac{1}{\frac{D ( i , j )}{255} * ( \frac{1}{{Z}_{near}} - \frac{1}{{Z}_{far}} ) + \frac{1}{{Z}_{far}}}$$

wherein Z_{far} is the farthest actual shooting distance, Zₙₑₐᵣ is the nearest actual shooting distance, D(i,j) is a pixel gray value of the second image pixel points corresponding to the current light-emitting sub-pixels in the source image on the depth image, and Z(i,j) is the actual shooting distance of the second image pixel points corresponding to the current light-emitting sub-pixels in the source image;
wherein the nearest actual shooting distance is the distance between the shooting lens and the position on the target object nearest the shooting lens, and the farthest actual shooting distance is the distance between the shooting lens and the position on the target object farthest from the shooting lens.

An embodiment of the present application further provides a driving device for a display device, comprising:
an input unit configured to input a source image, wherein the source image comprises depth information;
a search unit configured to search in the source image by utilizing the depth information to determine first image pixel points matched with light-emitting sub-pixels of the display device;
an assignment unit configured to assign pixel gray values of the first image pixel points to the light-emitting sub-pixels of the display device; and
a display unit configured to control the light-emitting sub-pixels to emit light according to assigned pixel gray values, so that the display device displays a multi-viewpoint image corresponding to the source image.

An embodiment of the present application further provides a display apparatus, comprising a display device and the driving device for the display device described as any embodiment above.

An embodiment of the present application further provides a computing and processing apparatus, comprising:
a memory, wherein a computer-readable code is stored in the memory; and
one or more processors, wherein when the computer-readable code is executed by the one or more processors, the computing and processing apparatus executes the driving method for the display device described as any embodiment above.

An embodiment of the present application further provides a computer program, comprising a computer-readable code, wherein the computer-readable code, when running on a computing and processing apparatus, causes the computing and processing apparatus to execute the driving method for the display device described as any embodiment above.

An embodiment of the present application further provides a computer-readable medium, wherein the computer program described above is stored in the computer-readable medium.

The above description is merely an overview of the technical solutions of the present application, which may be implemented in accordance with the contents of the description in order to make the technical means of the present application more clearly understood, and in order to make the above and other objects, features and advantages of the present application more apparent and understandable, specific embodiments of the present application are set forth below.

### BRIEF DESCRIPTION OF THE DRAWINGS

In order to explain the examples of the present application or the technical solutions in the related art more clearly, a brief description will be given below with reference to the accompanying drawings which need to be used in the description of the examples or the related art. Obviously, the accompanying drawings in the description below are intended for some examples of the present application, and for those ordinarily skilled in the art, other accompanying drawings may be obtained according to these accompanying drawings without involving any inventive effort.

FIG. 1 is a schematic diagram of an optical path of a 3D display device provided in the related art;

FIG. 2 is a schematic diagram of a flow chart of image processing provided in the related art;

FIG. 3 is a flow chart showing steps of a driving method for a display device according to an example of the present application;

FIG. 4 is a schematic diagram of a principle of image processing according to an example of the present application;

FIG. 5 is a schematic diagram of a flow chart of image processing according to an example of the present application;

FIG. 6 is a schematic diagram of a light-emitting sub-pixel array of the display device according to an example of the present application;

FIG. 7 is a schematic diagram of distribution of viewpoint numbers according to an example of the present application;

FIG. 8 is a schematic diagram of depth conversion according to an example of the present application;

FIG. 9 is a schematic diagram of 3D observation according to an example of the present application;

FIG. 10 is a block diagram showing a structure of a driving device for the display device according to an example of the present application;

FIG. 11 schematically shows a block diagram of a computing and processing apparatus for executing a method according to the present application; and

FIG. 12 schematically shows a storage unit for holding or carrying a program code implementing the method according to the present application.

### DETAILED DESCRIPTION

The technical solutions in examples of the present application will now be described clearly and completely below with reference to accompanying drawings in the examples of the present application. Obviously, the examples described are only some, but not all examples of the present application. Based on the examples in the present application, all other examples obtained by those ordinarily skilled in the art without involving any inventive effort fall within the protection scope of the present application.

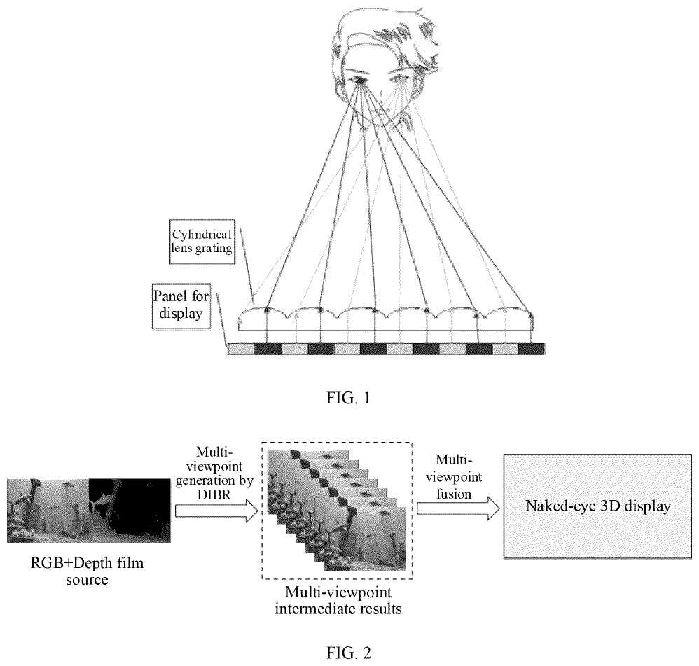

An existing naked-eye 3D display device has the problems of few observation viewpoints and discontinuous viewpoints. In order to improve the display effect of 3D display, a multi-viewpoint naked-eye 3D display device is provided in the related art. Referring to FIG. 1, FIG. 1 is a schematic diagram of an optical path of a 3D display device provided in the related art. As shown in FIG. 1, the multi-viewpoint naked-eye 3D display device in the related art may include: a display panel (for example, a Panel for display of FIG. 1) and an image splitting device (for example, a cylindrical lens grating of FIG. 1). The image splitting device may split light of light-emitting sub-pixels at different positions on the display panel into different positions in a space, and arrange and render a multi-viewpoint image according to the characteristic of light splitting for displaying on the display panel. After passing through the image splitting device, images at different viewpoints may be seen by two eyes of a person, and specifically a right-viewpoint image is received by the right eye simultaneously when a left-viewpoint image is received by the left eye, so that the person perceives the stereoscopic sense through brain processing.

However, in the related art, multi-viewpoint cameras are needed for shooting multi-viewpoint images, or a virtual-viewpoint image is generated according to an image shot by one camera based on a virtual-viewpoint rendering technology of a depth image, multi-viewpoint contents are generated for an original image to acquire images at multiple viewpoints, and then one multi-viewpoint image is obtained by multi-viewpoint fusion rendering, and displayed on the display device, wherein multi-viewpoint camera shooting requires multiple cameras to perform synchronous shooting, a quantity of the cameras used is the same as that of viewpoints, for example, 8 viewpoints require 8 cameras to perform shooting simultaneously, and an increase in the quantity of the cameras may result in an increase in the shooting cost.

Referring to FIG. 2, FIG. 2 is a schematic diagram of a flow chart of image processing provided in the related art. As shown in FIG. 2, in the related art, a flow of multi-viewpoint naked-eye 3D display may be performed in a depth-image-based rendering (DIBR) manner, wherein at least two processes of multi-viewpoint content acquisition and multi-viewpoint fusion rendering are contained. However, multi-viewpoint intermediate results require a huge amount of storage capacity, and occupy too much hardware storage resources, thereby being not conducive to hardware implementation, and then increasing the manufacturing cost. Moreover, the processing of multi-viewpoint contents also increases the operation time. Therefore, the processing efficiency of multi-viewpoint naked-eye 3D display needs to be improved urgently.

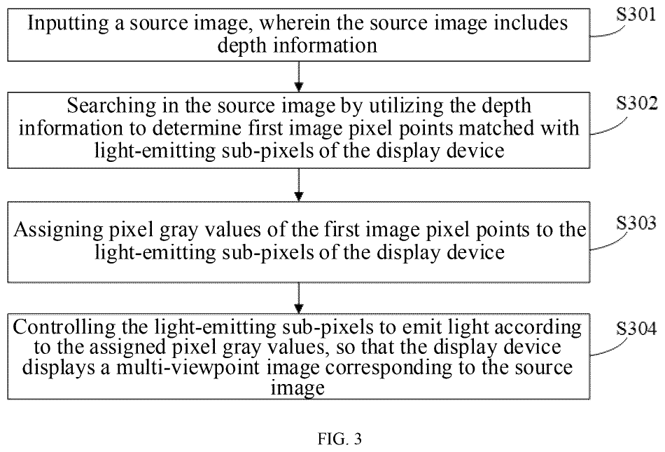

Referring to FIG. 3, FIG. 3 is a flow chart showing steps of a driving method for a display device provided in an example of the present application. As shown in FIG. 3, in order to solve the above problems, the present application provides a driving method for a display device, wherein the display device may include a display panel for performing multi-viewpoint naked-eye 3D display, the display panel may include a liquid crystal display (LCD) or organic light-emitting diode (OLED), and the driving method for the display device includes the following steps.

Step S301. Inputting a source image, wherein the source image includes depth information.

Preferably, the source image may also include a content image.

Preferably, the depth information may also include a depth image.

Wherein image pixel points in the source image may include corresponding image pixel points on the content image, and correspond to depth image pixel points on the depth image on a one-to-one basis.

In order to facilitate searching for first image pixel points matched with light-emitting sub-pixels of the display device, the depth image may be a gray image, each image pixel point in the source image may have a corresponding image position on the depth image, and a pixel gray value of the depth image pixel point at the image position may be used as depth information of pixel points of the source image, and indicate a distance between the image pixel points on the source image and a human eye. Therefore, the depth information may be represented by the pixel gray value of the depth image pixel point, the farther the actual distance between the pixel points of the source image and the human eye is, the greater the depth at the corresponding position on the depth image will be, and the less the pixel gray value of the depth image pixel point will be.

Preferably, the depth image may adopt an 8 bit gray value for representing the distance between the pixels on the source image and the human eye, wherein 255 represents the nearest distance from the person, and 0 represents the farthest distance from the person.

Step S302. Searching in the source image by utilizing the depth information to determine first image pixel points matched with light-emitting sub-pixels of the display device.

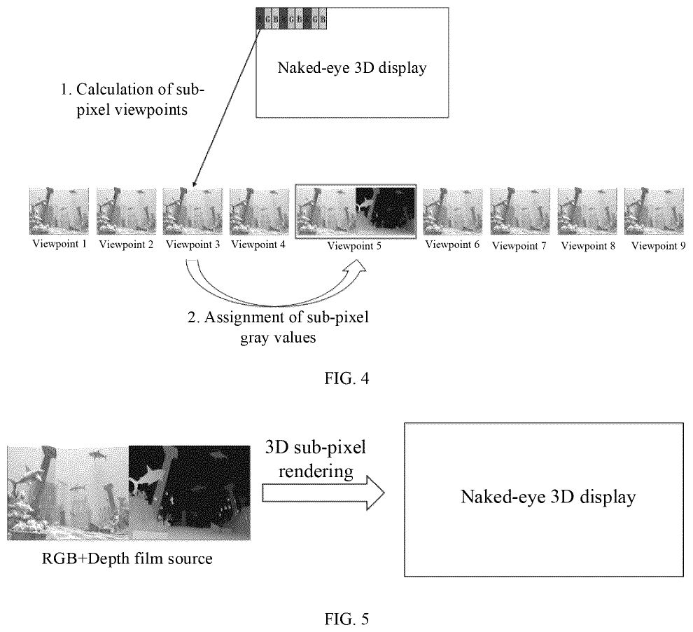

Referring to FIG. 4, FIG. 4 is a schematic diagram of a principle of image processing provided in an example of the present application. As shown in FIG. 4, firstly calculation of viewpoints of the display device may be performed, and then a parallax may be calculated according to the depth information in the source image, so that assignment of gray values of light-emitting sub-pixels may be performed, wherein a size ratio and a pixel resolution of the source image may be the same as those of the display device, and therefore, the light-emitting sub-pixels in the display device and the image pixel points in the source image may be in one-to-one correspondence from left to right and from top to bottom. For example, the pixel resolutions of both the source image and the display device may be 1,280 (a horizontal resolution)×720 (a longitudinal resolution).

Specifically, the first image pixel points are image pixel points in the source image which satisfy a preset parallax condition of the current light-emitting sub-pixels and are matched with the current light-emitting sub-pixels.

Wherein the parallax refers to a direction difference generated by observing the same target from two observation points with a certain distance, and wherein a parallax angle is an included angle between two points seen from the target, a width of a connecting line between the two points is a baseline width. From the parallax angle and the baseline width, the distance between the target and the observation point may be calculated.

Step S303. Assigning pixel gray values of the first image pixel points to the light-emitting sub-pixels of the display device.

Specifically, the pixel gray values of the first image pixel points may be used for representing image contents at positions of the first image pixel points on the source image. The source image may be an RGB image, and then the pixel gray values of the first image pixel points may be RGB pixel gray values consistent with RGB colors of the matched light-emitting sub-pixels.

Illustratively, the pixel gray values of the first image pixel points corresponding to the light-emitting sub-pixels may be red pixel gray values.

Further illustratively, the first image pixel points may correspond to red light-emitting sub-pixels, with pixel coordinates (M, N). The pixel gray values of the first image pixel points may be red pixel gray values, with pixel coordinates (R, S).

Step S304. Controlling the light-emitting sub-pixels to emit light according to the assigned pixel gray values, so that the display device displays a multi-viewpoint image corresponding to the source image.

Specifically, the display panel in the display device may include a plurality of pixels, each pixel may include light-emitting sub-pixels of at least three colors. Specifically, the light-emitting sub-pixels may include red light-emitting sub-pixels, blue light-emitting sub-pixels, and green light-emitting sub-pixels to form RGB light-emitting display. The light-emitting sub-pixels may also include white light-emitting sub-pixels to forming RGBW light-emitting display.

Wherein the multi-viewpoint image may be a multi-viewpoint naked-eye 3D image converted from the source image for allowing an observer to observe a stereoscopic picture on the display device. For example, the multi-viewpoint image may be a 9-viewpoint naked-eye 3D image.

According to the driving method for the display device provided in the present application, the first image pixel points satisfying the preset parallax condition are directly searched on the source image including the depth information, and pixel gray values of the first image pixel points are obtained according to the depth information of the first image for characterizing the depth information of multi-view 3D. Accordingly, the examples of the present application include the following advantages:

(1) the driving method for the display device provided in the examples of the present application does not need to utilize the source image for generating multiple virtual images respectively corresponding to multiple viewpoints, and also does not need fusion for generating the multiple-viewpoint image, thereby avoiding the generation and fusion of intermediate files, without the need for storing the intermediate files, saving hardware storage resources, and reducing the cost; and

(2) the driving method for the display device provided in the examples of the present application directly searches to obtain the contents to be displayed by various light-emitting sub-pixels of the display device, and displays the multi-viewpoint naked-eye 3D image in a manner of directly rendering the display device, so that the processing efficiency of the multi-viewpoint naked-eye 3D display may be effectively improved, and high-efficiency multi-viewpoint naked-eye 3D display may be achieved.

Referring to FIG. 5, FIG. 5 is a schematic diagram of a flowchart of image processing provided in an example of the present application. As shown in FIG. 5, according to the example of the present application, the first image pixel points satisfying the preset parallax condition may be directly searched on the source image including the depth information, and intermediate redundant processes of generating and re-fusing multi-viewpoint images are omitted, so that on the one hand, the storage of a large amount of intermediate image resources is avoided, and on the other hand, the processing efficiency of multi-viewpoint naked-eye 3D image display is also improved, and high-efficiency multi-viewpoint naked-eye 3D display is achieved, thereby being conducive to the popularization and development of the naked-eye 3D display technology.

As shown in FIG. 4, a 9-viewpoint naked-eye 3D display is illustrated, and under the condition that 8 virtual viewpoints need to be generated, baseline widths of various viewpoints are respectively set to be {4, 3, 2, 1, 0, −1, −2, −3, −4}.

After determining that the viewpoint number of the current light-emitting sub-pixel is any one of 1 to 9, and the resolution of the first image is consistent with that of the display, the first image pixel point which is matched with the current light-emitting sub-pixel and satisfies the preset parallax condition may be calculated in the same line of the source image.

In an optional embodiment, according to the example of the present application, the assignment processing of each light-emitting sub-pixel in the display device may be synchronously performed to achieve the maximum parallelization and improve the processing efficiency.

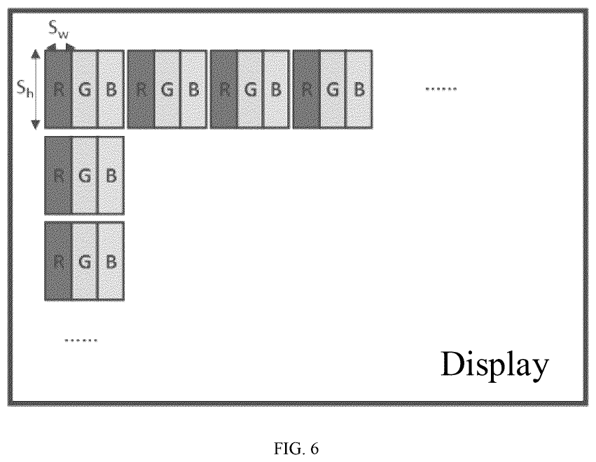

Referring to FIG. 6, FIG. 6 is a schematic diagram of a light-emitting sub-pixel array of the display device provided in an example of the present application. As shown in FIG. 6, the display device may include a display panel for RGB array display, wherein the light-emitting sub-pixels may be strip-shaped, and the RGB light-emitting sub-pixels are sequentially arranged in a horizontal direction along a short side, and the light-emitting sub-pixels of the same color are sequentially arranged in a vertical direction along a long side.

Considering that generally the resolution of the image may not be consistent with the size ratio or pixel resolution of the display device, in an optional embodiment, the present application further provides a method for image initialization, including:
obtaining an original image; and
initializing the original image to enable a horizontal resolution and/or longitudinal pixel resolution of the original image to be consistent with that of a display device to obtain a source image. Namely, the source image is an input image obtained by initializing the original image.

Specifically, if the size ratio of the original image is the same as that of the display device, the pixel resolution of the original image is consistent with that of the display device. In order to completely display the original image, if the size ratio of the original image is different from that of the display device, in the initialization, the horizontal maximum pixel resolution or the longitudinal maximum pixel resolution of the original image may be consistent with that of the display device by compressing the resolution or compensating the resolution while retaining the size ratio of the original image.

Illustratively, the pixel resolution of the display device is 1,280 (the horizontal resolution)×720 (the longitudinal resolution), the original image is a regular rectangular image, with the pixel resolution of 1,920 (the horizontal resolution)×1,080 (the longitudinal resolution), the horizontal maximum resolution of the original image may be compressed to 2/3 by compressing the resolution, namely 1,280, which is consistent with that of the display device, and the pixel resolution of the original image after the initialization is 1,280 (the horizontal resolution)×720 (the longitudinal resolution). Therefore, under the condition that the size ratio of the original image is the same as that of the display device, the size ratio of the initialized original image is still the same as that of the display device.

Further, under the condition that the size ratio of the original image is different from that of the display device, the processing is further performed in the following two cases.

In the first case, the horizontal-longitudinal size ratio of the original image is greater than that of the display device, and then the horizontal maximum pixel resolution of the original image should be consistent with that of the display device.

Illustratively, the pixel resolution of the original image is 2,160 (the horizontal resolution)×1,080 (the longitudinal resolution) with the horizontal-longitudinal size ratio of 2:1. The pixel resolution of the display device is 2,560 (the horizontal resolution)×1,080 (the longitudinal resolution) with the horizontal-longitudinal size ratio of 21:9. Then, the horizontal maximum pixel resolution of the original image is set to be 2,560 which is consistent with that of the display device, so as to completely display the original image.

In the second case, the horizontal-longitudinal size ratio of the original image is less than that of the display device, and then the horizontal maximum pixel resolution of the original image should be consistent with that of the display device.

Illustratively, the pixel resolution of the original image is 2,160 (the horizontal resolution)×1,080 (the longitudinal resolution) with the horizontal-longitudinal size ratio of 2:1. The pixel resolution of the display device is 1,280 (the horizontal resolution)×720 (the longitudinal resolution) with the horizontal-longitudinal size ratio of 16:9. Then, the horizontal maximum pixel resolution of the original image is set to be 1,280 which is consistent with that of the display device, so as to completely display the original image.

In yet another optional embodiment, according to the present application, pixel points in the original image may also be displayed by selecting the light-emitting sub-pixels in the display device at equal intervals, or the pixel points selected at equal intervals in the original image may be displayed by the light-emitting sub-pixels in the display device, so as to achieve the display of the light-emitting sub-pixels corresponding to the pixel points on a one-to-one basis and improve the display effect.

Wherein when the pixel resolution in any direction of the display device is less than that of the original image, the pixel points selected at equal intervals in the original image may be displayed by the light-emitting sub-pixels in the display device, and when the pixel resolution of the display device is greater than that of the original image, the pixel points in the original image may be displayed by selecting the light-emitting sub-pixels in the display device at equal intervals.

Illustratively, the pixel resolution of the display device is 1,280 (the horizontal resolution)×720 (the longitudinal resolution). The pixel resolution of the original image is 2,560 (the horizontal resolution)×1,440 (the longitudinal resolution). Then, the light-emitting sub-pixel array in the display device displays the pixel point array selected at every other light-emitting sub-pixel point on the original image.

In an example of the present application, considering that the first image pixel points satisfying the preset parallax condition are directly searched in the source image by viewpoint numbers of the light-emitting sub-pixels to omit hardware resources occupied by intermediate files, and improve the processing efficiency, to this end, in an optional embodiment, the present application further provides a method for searching first image pixel points, including:
searching in a source image according to viewpoint numbers of light-emitting sub-pixels and depth information to determine the first image pixel point matched with each of the light-emitting sub-pixels.

Wherein the viewpoint numbers are preset according to a quantity of viewpoints to be rendered, pixel coordinates of the light-emitting sub-pixels, and apparatus parameters of a display device.

Specifically, the viewpoint numbers may be used for dividing the light-emitting sub-pixels in the display device into multi-viewpoint light-emitting sub-pixels in corresponding rendering quantities, and the multi-viewpoint light-emitting sub-pixels are respectively used for displaying images in multiple viewpoint directions. Illustratively, the quantity of the viewpoints may be 9, and then the viewpoints of the light-emitting sub-pixels in the display device may be numbered from 1 to 9, and 9 types of light-emitting sub-pixels with the viewpoints numbers of 1 to 9 are respectively used for displaying images in 9 viewpoint directions.

Wherein the viewpoint numbers may characterize multiple viewpoint directions, and the viewpoint directions may determine the parallax, and therefore may also be used for calculating the parallax of second image pixel points corresponding to the light-emitting sub-pixels in the source image.

Through the above example, the present application achieves the arrangement and calculation of the viewpoints of the light-emitting sub-pixels of the display device, so as to further achieve multi-viewpoint fusion and rendering.

Further, in an optional embodiment, the present application further provides a method for determining first image pixel points, including:

Step 401. obtaining a parallax of second image pixel points corresponding to current light-emitting sub-pixels in a source image according to viewpoint numbers of the current light-emitting sub-pixels; wherein pixel coordinates of the current light-emitting sub-pixels and pixel coordinates of the second image pixel points are mapped on a one-to-one basis.

Wherein under the condition that the size ratio and pixel resolution of the source image are the same as those of the display device, the pixel coordinates of the light-emitting sub-pixels of the display device and the pixel coordinates of the pixel points in the source image are mapped on a one-to-one basis, and it may include that the pixel coordinates of the light-emitting sub-pixels of the display device and the pixel coordinates of the pixel points in the source image are the same. Illustratively, when the pixel coordinates of the current light-emitting sub-pixels are (M, N), the pixel coordinates of the pixel points in the mapped source image are also (M, N).

Step 402. Searching in a preset parallax range in the source image according to the parallax of the second image pixel points to determine first image pixel points matched with the current light-emitting sub-pixels.

Specifically, searching may be performed in a range of the source image corresponding to the second image pixel points, and pixel points satisfying the preset parallax condition are determined as the first image pixel points.

In an example of the present application, further considering that the parallax of the pixel points is obtained by parameters such as an actual shooting distance of the pixel points, to this end, in an optional embodiment, the present application further provides a method for obtaining the parallax of the pixel points, including:

Step S501. obtaining an actual shooting distance of the second image pixel points according to depth information of the second image pixel points.

Wherein the actual shooting distance of the pixel points corresponding to the current light-emitting sub-pixels in the source image refers to an actual shooting distance between positions corresponding to the pixel points on a target object and a shooting lens in a shooting scene.

Step S502. obtaining the parallax of the second image pixel points according to viewpoint numbers of the current light-emitting sub-pixels and the actual shooting distance of the second image pixel points.

Specifically, the nearest actual shooting distance and the farthest actual shooting distance between the target object in the shooting scene and the shooting lens may be obtained by the depth information carried in the depth image, and the actual shooting distance of the pixel points corresponding to the current light-emitting sub-pixels in the source image may be further obtained by the nearest actual shooting distance, the farthest actual shooting distance, and pixel gray values of the pixel points corresponding to the current light-emitting sub-pixels in the source image.

Wherein the nearest actual shooting distance is a distance between the shooting lens and a position on the target object nearest the shooting lens, and the farthest actual shooting distance is a distance between the shooting lens and a position on the target object farthest from the shooting lens.

As the parallax of the pixel points is affected by shooting parameters of the image, apparatus parameters of multi-viewpoint rendering, and observation parameters, according to the example of the present application, a corresponding equation may be established on the basis of obtaining the actual shooting distance of the pixel points to obtain the parallax of the pixel points. Further, in an optional embodiment, the present application further provides a method for obtaining the parallax of second image pixel points, including:
Step S503. obtaining a baseline width according to a quantity of viewpoints to be rendered and viewpoint numbers of current light-emitting sub-pixels;
Step S504. obtaining the parallax of the second image pixel points according to the baseline width, a shooting focal length of the source image, and a distance parameter difference value between the second image pixel points and a zero parallax plane; and
Step S505. obtaining the distance parameter difference value between the second image pixel points and the zero parallax plane according to the actual shooting distance of the second image pixel points and an actual distance of the zero parallax plane.

In conjunction with the above example, the present application provides an illustrative example for obtaining the parallax of pixel points, including:
calculating the parallax of the second image pixel points according to the following formula:

$$B = int ( \frac{V}{2} ) + 1 - {V}_{i , j} , Dis ( i , j ) = F * B * ( \frac{1}{Z ( i , j )} - \frac{1}{{Z}_{zero}} )$$

wherein V_{i,j} is the viewpoint numbers of the current light-emitting sub-pixels, V is the quantity of the viewpoints to be rendered, Dis(i,j) is the parallax of the second image pixel points, Z(i,j) is the actual shooting distance of the second image pixel points, F is the shooting focal length of the source image, B is the baseline width, and Z_{zero} is a zero parallax distance.

Wherein the zero parallax distance is a distance between the zero parallax plane and the shooting lens, and the zero parallax plane refers to a plane coinciding with a naked-eye 3D screen after a three-dimensional scene is reconstructed.

In an optional embodiment, the depth information includes a depth image, wherein the image pixel points in the depth image and the depth image pixel points in the source image are mapped on a one-to-one basis. The pixel gray values of the depth image pixel points mapped by the second image pixel points in the depth image are used for representing the depth information of the second image pixel points.

Referring to FIG. 8, FIG. 8 is a schematic diagram of depth conversion provided in an example of the present application. As shown in FIG. 8, the actual shooting distance of the pixel points is actually obtained by fitting, and in fact there is a linear or non-linear relationship between the depth information in the depth image and the shooting distance, to this end, in conjunction with the above example, in an optional embodiment, the present application further provides a method for the actual shooting distance of the second image pixel points, including:
obtaining the actual shooting distance of the second image pixel points according to the pixel gray values of the depth image pixel points mapped by the second image pixel points in the depth image in a linear conversion manner and/or non-linear conversion manner.

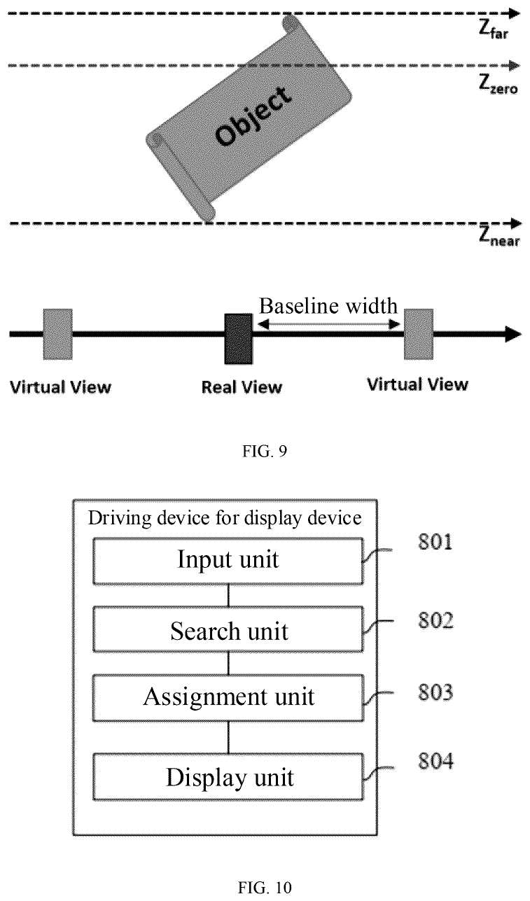

Referring to FIG. 9, FIG. 9 is a schematic diagram of 3D observation provided in an example of the present application. As shown in FIG. 9, the example of the present application further provides an example for obtaining the actual shooting distance of the pixel points corresponding to the current light-emitting sub-pixels in the source image according to the depth image in a linear conversion manner by the following fomula:

$$Z ( i , j ) = {Z}_{near} - {Z}_{far} ) * \frac{D ( i , j )}{255} + {Z}_{far}$$

wherein Z_{far} is a farthest actual shooting distance, Zₙₑₐᵣ is a nearest actual shooting distance, and D(i,j) is pixel gray values of the second image pixel points corresponding to the current light-emitting sub-pixels in the source image on the depth image.

The example of the present application further provides an example for obtaining the actual shooting distance of the pixel points corresponding to the current light-emitting sub-pixels in the source image according to the depth image in a non-linear conversion manner by the following formula:

$$Z ( i , j ) = \frac{1}{\frac{D ( i , j )}{255} * ( \frac{1}{{Z}_{near}} - \frac{1}{{Z}_{far}} ) + \frac{1}{{Z}_{far}}}$$

wherein Z_{far} is the farthest actual shooting distance, Zₙₑₐᵣ is the nearest actual shooting distance, D(i,j) is the pixel gray values of the second image pixel points corresponding to the current light-emitting sub-pixels in the source image on the depth image, and Z(i,j) is the actual shooting distance of the pixel points corresponding to the current light-emitting sub-pixels in the source image.

According to the above example, the parallax of the pixel points corresponding to the current light-emitting sub-pixels in the source image may be determined, and in a preset parallax range, first image pixel points matched with a parallax position of the current light-emitting sub-pixels in the source image satisfying a preset parallax condition as the parallax of the corresponding pixel points may be further determined, namely, to this end, in an optional embodiment, the present application further provides a method for determining first image pixel points, including:
traversing and searching first image pixel points in the source image in the preset parallax range based on second image pixel points.

In the case where the parallax position of the current image pixel points satisfies the preset parallax condition, it is determined that the current image pixel points are the first image pixel points.

The preset parallax range includes: traversing a position range of a preset quantity of image pixel points along an image pixel line where the second image pixel points are located based on a position of the second image pixel points.

Illustratively, the preset parallax range may be a pixel parallax range corresponding to the pixel points corresponding to the current light-emitting sub-pixels in the source image, and may be preset. Illustratively, for example, the preset parallax range is a range in which pixel points of ±64 pixels in the same line of the second image pixel points are located.

Specifically, the preset parallax condition may be that a difference between a distance value between the current parallax position and the pixel points corresponding to the current light-emitting sub-pixels in the source image in the preset parallax range, and the parallax of the pixel points corresponding to the current light-emitting sub-pixels in the source image is less than 1. To this end, in an optional embodiment, the present application further provides a preset parallax condition, including:
a sum of a pixel coordinate difference between the current image pixel points and the second image pixel points, and the parallax of the second image pixel points being less than 1.

The pixel coordinate difference between the current image pixel points and the second image pixel points includes: a difference between column pixel coordinates of the current image pixel points and column pixel coordinates of the second image pixel points.

Considering that the pixel resolution of the source image may be consistent with that of the display device by initialization of the source image, calculation may be performed on the same line of the source image for the current position, namely only one line of data needs to be stored, to this end, in an optional example,
the preset parallax condition is that the following formula is satisfied:

|j1+Dis(i,j)−j|<1
wherein j1 is longitudinal pixel coordinates of the current picture pixel points, j is longitudinal pixel coordinates of the second image pixel points, and Dis(i,j) is the parallax of the second image pixel points.

In multi-viewpoint 3D display, in order to ensure that a foreground may not be shielded by a background, after obtaining virtual viewpoints, voids are likely to be generated with a boundary due to shielding of the foreground and the background, and therefore void recovering is needed for optimizing the image quality of the virtual viewpoints and filling the voids. To this end, in an optional embodiment, the present application further provides a method for filling voids, and the method further includes:
Step 601. after traversing and searching all the image pixel points in the preset parallax range, if there is no image pixel point satisfying the preset parallax condition, determining that the current light-emitting sub-pixels are voids;
Step 602. after determining that the current light-emitting sub-pixels are voids, obtaining a pixel gray value of an image pixel point with a minimum depth in the preset parallax range based on the second image pixel points; and
Step 603. assigning the pixel gray value of the image pixel point with the minimum depth to the current light-emitting sub-pixels.

Through the above example, positions of voids may be taken as the background by assigning the pixels with the minimum depth in the search range, so as to improve the overall impression of the picture.

In the example of the present application, the viewpoint numbers of the light-emitting sub-pixels are also considered to be preset to directly perform gray value assignment according to the first image, to this end, in an optional embodiment, the present application further provides a display device, and the display device includes: an image splitting device and a display panel; and the image splitting device includes at least one grating unit, wherein light-emitting sub-pixels corresponding at the same position of different grating units have the same viewpoint numbers.

The apparatus parameters of the display device include: a length of the light-emitting sub-pixels, a width of the light-emitting sub-pixels, a fitting angle of the image splitting device, a width of the grating unit, and a pixel resolution of the display panel.

Wherein the fitting angle of the image splitting device may be an angle between the grating of the image splitting device and a plane where the display panel is located.

Wherein a plurality of grating units may be arranged in parallel, and each grating unit is an image splitting unit. The grating unit specifically may include a slit grating unit or a cylindrical lens grating unit.

Wherein the image splitting device may be fitted to a light-emitting side of the display panel at a preset angle.

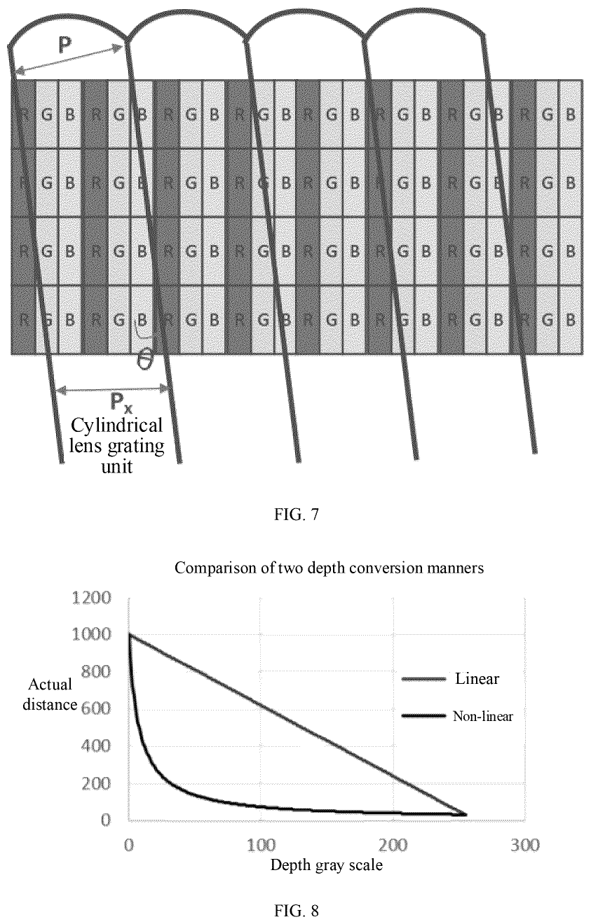

Referring to FIG. 7, FIG. 7 is a schematic diagram of distribution of viewpoint numbers provided in an example of the present application. As shown in FIG. 7, according to the example of the present application, the viewpoint numbers may also be determined by utilizing apparatus parameters of the display device and the image splitting device. To this end, in an optional embodiment, the present application further provides a method for determining viewpoint numbers, including:
Step 701. obtaining a quantity of viewpoint sub-pixels of each light-emitting sub-pixel line according to the width of the grating units of the image splitting device, the length of the light-emitting sub-pixels, and the fitting angle of the image splitting device;
Step 702. obtaining an offset quantity of two adjacent lines of light-emitting sub-pixels according to the length of the light-emitting sub-pixels, the width of the light-emitting sub-pixels, and the fitting angle of the image splitting device; and
Step 703. obtaining the viewpoint number of any one of the light-emitting sub-pixels in the display device according to the quantity of the viewpoint sub-pixels of each light-emitting sub-pixel line, and the offset quantity of the two adjacent lines of the light-emitting sub-pixels.

Further, in an optional embodiment, the present application further provides a method for determining viewpoint numbers, including:
Step 704. obtaining a quantity of viewpoints corresponding to a horizontal unit light-emitting sub-pixel length according to the quantity of the viewpoint sub-pixels of each light-emitting sub-pixel line, and the quantity of the viewpoints to be rendered;
Step 705. obtaining a quantity of viewpoints corresponding to a longitudinal unit light-emitting sub-pixel length according to the offset quantity of the two adjacent lines of the light-emitting sub-pixels, and the quantity of the viewpoints corresponding to the horizontal unit light-emitting sub-pixel length;
Step 706. determining a viewpoint number to which a first light-emitting sub-pixel of each line belongs according to a first calculated viewpoint number of the light-emitting sub-pixel and a horizontal resolution of the display panel; and
Step 707. obtaining a viewpoint number of any one of the light-emitting sub-pixels in the display device according to the viewpoint number to which the first light-emitting sub-pixel of each line belongs, and a longitudinal resolution of the display panel.

In conjunction with the above example, the present application further provides an illustrative example, and the viewpoint numbers of the light-emitting sub-pixels of the display device may be calculated according to the following formula:

$${P}_{x} = \frac{P}{{S}_{w} * cos ( θ )}$$

$${Shift}_{x} = \frac{{S}_{h}}{{S}_{w}} * tan ( θ )$$

$${V}_{x} = \frac{V}{{P}_{x}}$$

$${V}_{y} = {V}_{x} * {Shift}_{x}$$

$${V}_{ahead} = ( {V}_{first} - ( i - 1 ) * {V}_{y} ) \% V , if ( {V}_{ahead} == 0 ) , {V}_{aead} = V , i ∈ [ 1 , P\_rows ]$$

$${V}_{i , j} = ( {V}_{ahead} + ( j - 1 ) * {V}_{x} ) \% V , if ( {V}_{i , j} == 0 ) , {V}_{i , j} = V , j ∈ [ 1 , 3 * P\_cols ]$$

wherein Pₓ is the quantity of the viewpoint sub-pixels of each line, P is the width of the grating units, S_{w} is the width of the light-emitting sub-pixels, θ is the fitting angle of the image splitting device, Shiftₓ is the offset quantity of the adjacent lines of the light-emitting sub-pixels, Sₕ is the length of the light-emitting sub-pixels, Vₓ is the quantity of the viewpoints contained in a horizontal unit light-emitting sub-pixel distance, Vₓ is the quantity of the viewpoints included in a longitudinal unit light-emitting sub-pixel distance, V is the quantity of the viewpoints to be rendered, V_{ahead} is the viewpoint to which the first light-emitting sub-pixel of each line belongs, V_{first} is the viewpoint number of the first calculated light-emitting sub-pixel, i is the horizontal pixel coordinate of the current light-emitting sub-pixel, j is the longitudinal pixel coordinate of the current light-emitting sub-pixel, P__{rows} is the horizontal resolution of the display panel, and P-cods is the longitudinal resolution of the display panel.

Wherein the viewpoint numbers may also be reset according to the quantity of the viewpoints to be rendered.

Through the above example, the quantity of the viewpoint sub-pixels of each line may be calculated according to the width of the grating units of the image splitting device, the length of the light-emitting sub-pixels, and the fitting angle of the image splitting device in the example of the present application, and then the viewpoint numbers may be further obtained according to an arrangement mode of the light-emitting sub-pixels of the display device and may be repeatedly used for assignment of pixel gray values of different images, thereby improving the processing efficiency of multi-viewpoint rendering.

Referring to FIG. 10, FIG. 10 is a block diagram showing a structure of a driving device for the display device provided in an example of the present application. As shown in FIG. 10, in conjunction with the above examples, based on the similar inventive concept, the example of the present application further provides the driving device for the display device, including:
an input unit 801 configured to input a source image, wherein the source image includes depth information;
a search unit 802 configured to search in the source image by utilizing the depth information to determine first image pixel points matched with light-emitting sub-pixels of the display device;
an assignment unit 803 configured to assign pixel gray values of the first image pixel points to the light-emitting sub-pixels of the display device; and
a display unit 804 configured to control the light-emitting sub-pixels to emit light according to the assigned pixel gray values, so that the display device displays a multi-viewpoint image corresponding to the source image.

Through the above example, the example of the present application provides the driving device for the display device, which directly performs 3D rendering on the display device and drives the display. For the same or similar reasons, the above advantages of the driving method for the display device of the foregoing examples are also included.

Based on the same inventive concept, an example of the present application further provides a display apparatus, wherein the display apparatus includes the display device of any one of the examples described above.

Through the above example, the example of the present application provides the driving device for the display device, and the driving device for the display device directly performs 3D rendering on the display device and drives the display. For the same or similar reasons, the above advantages of the driving method for the display device are also included.

An example of the present application further provides a computing and processing apparatus, including:
a memory, wherein a computer-readable code is stored in the memory; and
one or more processors, wherein when the computer-readable code is executed by the one or more processors, the computing and processing apparatus executes the driving method for the display device according to any one of the above examples.

An example of the present application further provides a computer program, including a computer-readable code, wherein the computer-readable code, when running on the computing and processing apparatus, causes the computing and processing apparatus to execute the driving method for the display device according to any one of the above examples.

An example of the present application further provides a computer-readable medium, wherein the computer program as described above is stored in the computer-readable medium.

Various examples in this description are all described in an incremental manner, each example focuses on differences from other examples, and same and similar parts among various examples may refer to each other.

Finally, it is also noted that relational terms such as first and second are only used herein for distinguishing one entity or action from another entity or action without necessarily requiring or implying any actual such relationship or order between such entities or actions. Furthermore, the terms “including”, “containing”, or any other variations thereof, are intended to cover a non-exclusive inclusion, so that a process, method, article, or apparatus which includes a series of elements does not include only those elements but may include other elements not expressly listed or inherent to such process, method, article, or apparatus. An element proceeded by the phrase “including a” does not, without more constraints, preclude the existence of additional identical elements in the process, method, article, or apparatus which includes the element.

The driving method for the display device, the driving device for the display device, and the display apparatus provided in the present application have been described in detail above, and the principles and embodiments of the present application have been set forth herein by applying specific examples. The above description of the examples is only used for helping understand the method and the core idea of the present application. Meanwhile, for those ordinarily skilled in the art, according to the idea of the present application, there would be changes in the specific embodiments and the application scope, and in summary, the contents of the present description should not be construed as limiting the present application.

Other embodiments of the present application will be apparent to those skilled in the art from consideration of the description and practice of the present application herein, the present application is intended to cover any variations, uses, or adaptations of the present application, and these variations, uses, or adaptations follow general principles of the present application and include common general knowledge or customary technical means in this technical field which is not disclosed in the present application. It is intended that the description and examples are considered as exemplary only, with the true scope and spirit of the present application being indicated by the following claims.

It should be understood that the present application is not limited to the precise structures described above and shown in the accompanying drawings, and various modifications and changes may be made without departing from the scope thereof. The scope of the present application is limited only by the appended claims.

Various component examples of the present application may be implemented in hardware, or in a software module running on one or more processors, or in a combination thereof. Those skilled in the art will understand that a microprocessor or digital signal processor (DSP) may be used in practice for implementing some or all of the functions of some or all of the components in the computing and processing apparatus according to the example of the present application, the present application may also be implemented as an apparatus or device program (for example, a computer program and a computer program product) for executing some or all of the methods described herein. Such a program implementing the present application may be stored on the computer-readable medium, or may be in the form of one or more signals. Such signals may be downloaded from an Internet website, provided on a carrier signal, or provided in any other form.

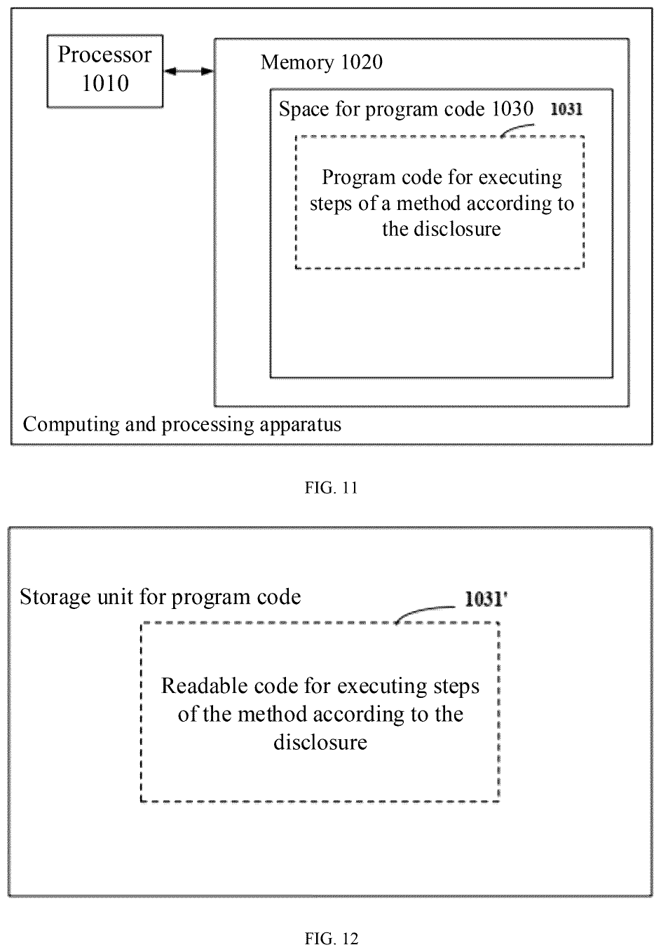

For example, FIG. 11 shows the computing and processing apparatus which may implement the method according to the present application. The computing and processing apparatus conventionally includes a processor 1010 and a computer program product or computer-readable medium in the form of a memory 1020. The memory 1020 may be an electronic memory such as a flash memory, an electrically erasable programmable read only memory (EEPROM), an EPROM, a hard disk, or an ROM. The memory 1020 has a storage space 1030 for a program code 1031 for executing any method step in the method described above. For example, the storage space 1030 for the program code may include various program codes 1031 for implementing various steps in the above method, respectively. The program codes may be read from or written into one or more computer program products. These computer program products include a program code carrier such as a hard disk, a compact disc (CD), a storage card, or a floppy disk. Such a computer program product is generally a portable or fixed storage unit as described with reference to FIG. 12. The storage unit may have storage segments, storage space and the like arranged similarly to the memory 1020 in the computing and processing apparatus of FIG. 11. The program code may, for example, be compressed in a suitable form. Generally, the storage unit includes computer-readable codes 1031′, namely codes which may be read by, for example, a processor such as the processor 1010, and these codes, when run by the computing and processing apparatus, cause the computing and processing apparatus to execute various steps in the method described above.

Reference herein to “one example”, “example”, or “one or more examples” means that a particular feature, structure, or characteristic described in connection with the examples is included in at least one example of the present application. In addition, it is noted that instances of the word “in one example” herein are not necessarily all referring to the same example.

In the description provided herein, numerous specific details are set forth. However, it is understood that examples of the present application may be practiced without these specific details. In some instances, well-known methods, structures and techniques have not been shown in detail in order not to obscure the understanding of this description.

In the claims, any reference signs placed between parentheses shall not be construed as limiting the claims. The word “containing” does not exclude the presence of elements or steps other than those listed in the claims. The word “a” or “an” preceding an element does not exclude the presence of a plurality of such elements. the present application may be implemented by means of hardware including a plurality of distinct elements, and by means of a suitably programmed computer. In the unit claims enumerating a plurality of devices, a plurality of devices in these devices may be specifically embodied by the same hardware item. The use of the words such as first, second, and third does not denote any order. These words may be interpreted as names.

Finally, it should be noted that the above examples am merely illustrative of the technical solutions of the present application, and do not limit the same; although the present application has been described in detail with reference to the foregoing examples, those ordinarily skilled in the art will understand that the technical solutions disclosed in various examples described above may still be modified, or some of the technical features thereof may be replaced with equivalents; however, these modifications or replacements do not enable the essence of the corresponding technical solutions to be depart from the spirit and scope of the technical solutions of various examples of the present application.

1. A driving method for a display device, comprising:
inputting a source image, wherein the source image comprises depth information;
searching in the source image by utilizing the depth information to determine first image pixel points matched with light-emitting sub-pixels of the display device;
assigning pixel gray values of the first image pixel points to the light-emitting sub-pixels of the display device; and
controlling the light-emitting sub-pixels to emit light according to assigned pixel gray values, so that the display device displays a multi-viewpoint image corresponding to the source image.

2. The driving method for the display device according to claim 1, wherein the step of searching in the source image by utilizing the depth information to determine first image pixel points matched with light-emitting sub-pixels of the display device comprises:
searching in the source image according to viewpoint numbers of the light-emitting sub-pixels and the depth information to determine the first image pixel point matched with each of the light-emitting sub-pixels;
wherein the viewpoint numbers are preset according to a quantity of viewpoints to be rendered, pixel coordinates of the light-emitting sub-pixels, and apparatus parameters of the display device.

3. The driving method for the display device according to claim 2, wherein the step of searching in the source image according to viewpoint numbers of the light-emitting sub-pixels and the depth information to determine the first image pixel point matched with each of the light-emitting sub-pixels comprises:
obtaining a parallax of second image pixel points corresponding to current light-emitting sub-pixels in the source image according to the viewpoint numbers of the current light-emitting sub-pixels; wherein the pixel coordinates of the current light-emitting sub-pixels and pixel coordinates of the second image pixel points are mapped on a one-to-one basis; and
searching in a preset parallax range in the source image according to the parallax of the second image pixel points to determine first image pixel points matched with the current light-emitting sub-pixels.

4. The driving method for the display device according to claim 3, wherein the step of obtaining a parallax of second image pixel points corresponding to current light-emitting sub-pixels in the source image according to the viewpoint numbers of the current light-emitting sub-pixels comprises:
obtaining an actual shooting distance of the second image pixel points according to depth information of the second image pixel points; and
obtaining the parallax of the second image pixel points according to the viewpoint numbers of the current light-emitting sub-pixels and the actual shooting distance of the second image pixel points.

5. The driving method for the display device according to claim 4, wherein the depth information comprises a depth image; wherein image pixel points in the depth image and depth image pixel points in the source image are mapped on a one-to-one basis; and pixel gray values of the depth image pixel points mapped by the second image pixel points in the depth image are used for representing depth information of the second image pixel points; and
the step of obtaining an actual shooting distance of the second image pixel points according to depth information of the second image pixel points comprises:
obtaining the actual shooting distance of the second image pixel points according to the pixel gray values of the depth image pixel points mapped by the second image pixel points in the depth image in a linear conversion manner and/or non-linear conversion manner.

6. The driving method for the display device according to claim 4, wherein the step of obtaining the parallax of the second image pixel points according to the viewpoint numbers of the current light-emitting sub-pixels and the actual shooting distance of the second image pixel points comprises:
obtaining a baseline width according to the quantity of the viewpoints to be rendered and the viewpoint numbers of the current light-emitting sub-pixels;
obtaining the parallax of the second image pixel points according to the baseline width, a shooting focal length of the source image, and a distance parameter difference value between the second image pixel points and a zero parallax plane;
wherein the distance parameter difference value between the second image pixel points and the zero parallax plane is obtained according to the actual shooting distance of the second image pixel points and an actual distance of the zero parallax plane.

7. The driving method for the display device according to claim 3, wherein the step of searching in a preset parallax range in the source image according to the parallax of the second image pixel points to determine first image pixel points matched with the current light-emitting sub-pixels comprises:
traversing and searching the first image pixel points in the source image in the preset parallax range based on the second image pixel points;
wherein in the case where a parallax position of current image pixel points satisfies a preset parallax condition, it is determined that the current image pixel points are the first image pixel points;
wherein the preset parallax range comprises: traversing a position range of a preset quantity of image pixel points along an image pixel line where the second image pixel points are located based on a position of the second image pixel points.

8. The driving method for the display device according to claim 7, wherein the preset parallax condition comprises:
a sum of a pixel coordinate difference between the current image pixel points and the second image pixel points and the parallax of the second image pixel points being less than 1; and
wherein the pixel coordinate difference between the current image pixel points and the second image pixel points comprises: a difference between a column pixel coordinate of the current image pixel points and a column pixel coordinate of the second image pixel points.

9. The driving method for the display device according to claim 8, wherein the method further comprises:
after traversing and searching all the image pixel points in the preset parallax range, under the condition that there is no image pixel point satisfying the preset parallax condition, determining that the current light-emitting sub-pixels are voids;
after determining that the current light-emitting sub-pixels are voids, obtaining a pixel gray value of an image pixel point with a minimum depth in the preset parallax range based on the second image pixel points; and
assigning the pixel gray value of the image pixel point with the minimum depth to the current light-emitting sub-pixels.

10. The driving method for the display device according to claim 2, wherein the display device comprises: an image splitting device and a display panel; the image splitting device comprises at least one grating unit, wherein light-emitting sub-pixels corresponding to same positions of different grating units have same viewpoint numbers; and
the apparatus parameters of the display device comprise: a length of the light-emitting sub-pixels, a width of the light-emitting sub-pixels, a fitting angle of the image splitting device, a width of the grating unit, and a pixel resolution of the display panel.

11. The driving method for the display device according to claim 10, wherein before the step of searching in the source image by utilizing the depth information to determine first image pixel points matched with light-emitting sub-pixels of the display device, the method further comprises:
obtaining a quantity of viewpoint sub-pixels of each light-emitting sub-pixel line according to the width of the grating unit of the image splitting device, the length of the light-emitting sub-pixels, and the fitting angle of the image splitting device;
obtaining an offset quantity of two adjacent lines of light-emitting sub-pixels according to the length of the light-emitting sub-pixels, the width of the light-emitting sub-pixels, and the fitting angle of the image splitting device; and
obtaining the viewpoint number of any one of the light-emitting sub-pixels in the display device according to the quantity of the viewpoint sub-pixels of each light-emitting sub-pixel line, and the offset quantity of the two adjacent lines of the light-emitting sub-pixels.

12. The driving method for the display device according to claim 11, wherein the step of obtaining the viewpoint number of any one of the light-emitting sub-pixels in the display device according to the quantity of the viewpoint sub-pixels of each light-emitting sub-pixel line, and the offset quantity of the two adjacent lines of the light-emitting sub-pixels comprises:
obtaining a quantity of viewpoints corresponding to a horizontal unit light-emitting sub-pixel length according to the quantity of the viewpoint sub-pixels of each light-emitting sub-pixel line, and the quantity of the viewpoints to be rendered;
obtaining a quantity of viewpoints corresponding to a longitudinal unit light-emitting sub-pixel length according to the offset quantity of the two adjacent lines of the light-emitting sub-pixels, and the quantity of the viewpoints corresponding to the horizontal unit light-emitting sub-pixel length;
determining a viewpoint number to which a first light-emitting sub-pixel of each line belongs according to a first calculated viewpoint number of the light-emitting sub-pixel and a horizontal resolution of the display panel; and
obtaining a viewpoint number of any one of the light-emitting sub-pixels in the display device according to the viewpoint number to which the first light-emitting sub-pixel of each line belongs, and a longitudinal resolution of the display panel.

13. The driving method for the display device according to claim 1, wherein before the step of searching in the source image by utilizing the depth information to determine first image pixel points matched with light-emitting sub-pixels of the display device, the method further comprises:
obtaining an original image; and
initializing the original image to enable a horizontal resolution and/or longitudinal pixel resolution of the original image to be consistent with that of the display device to obtain the source image.

14. The driving method for the display device according to claim 3, wherein a calculation formula of the parallax of the second image pixel points is as follows:
$$B = int ( \frac{V}{2} ) + 1 - {V}_{i , j} , Dis ( i , j ) = F * B * ( \frac{1}{Z ( i , j )} - \frac{1}{{Z}_{zero}} )$$
wherein V_{i,j} is the viewpoint numbers of the current light-emitting sub-pixels, V is the quantity of the viewpoints to be rendered, Dis(i,j) is the parallax of the second image pixel points, Z(i,j) is the actual shooting distance of the second image pixel points, F is the shooting focal length of the source image, B is the baseline width, and Z_{zero} is a zero parallax distance;
wherein the zero parallax distance is a distance between the zero parallax plane and a shooting lens, and the zero parallax plane refers to a plane coinciding with a naked-eye 3D screen after a three-dimensional scene is reconstructed.

15. The driving method for the display device according to claim 5, wherein a calculation formula for obtaining the actual shooting distance of the second image pixel points according to the pixel gray values of the depth image pixel points mapped by the second image pixel points in the depth image in a linear conversion manner is as follows:
$$Z ( i , j ) = ( {Z}_{near} - {Z}_{far} ) * \frac{D ( i , j )}{255} + {Z}_{far}$$
wherein Z_{far} is a farthest actual shooting distance, Zₙₑₐᵣ is a nearest actual shooting distance, and D(i,j) is a pixel gray value of the second image pixel points corresponding to the current light-emitting sub-pixels in the source image on the depth image, and Z(i,j) is the actual shooting distance of the second image pixel points corresponding to the current light-emitting sub-pixels in the source image;
wherein the nearest actual shooting distance is a distance between the shooting lens and a position on a target object nearest the shooting lens, and the farthest actual shooting distance is a distance between the shooting lens and a position on the target object farthest from the shooting lens.

16. The driving method for the display device according to claim 5, wherein a calculation formula for obtaining the actual shooting distance of the second image pixel points according to the pixel gray values of the depth image pixel points mapped by the second image pixel points in the depth image in a non-linear conversion manner is as follows:
$$Z ( i , j ) = \frac{1}{\frac{D ( i , j )}{255} * ( \frac{1}{{Z}_{near}} - \frac{1}{{Z}_{far}} ) + \frac{1}{{Z}_{far}}}$$
wherein Z_{far} is the farthest actual shooting distance, Zₙₑₐᵣ is the nearest actual shooting distance, D(i,j) is a pixel gray value of the second image pixel points corresponding to the current light-emitting sub-pixels in the source image on the depth image, and Z(i,j) is the actual shooting distance of the second image pixel points corresponding to the current light-emitting sub-pixels in the source image;
wherein the nearest actual shooting distance is the distance between the shooting lens and the position on the target object nearest the shooting lens, and the farthest actual shooting distance is the distance between the shooting lens and the position on the target object farthest from the shooting lens.

17. A driving device for a display device, comprising:
an input unit configured to input a source image, wherein the source image comprises depth information;
a search unit configured to search in the source image by utilizing the depth information to determine first image pixel points matched with light-emitting sub-pixels of the display device;
an assignment unit configured to assign pixel gray values of the first image pixel points to the light-emitting sub-pixels of the display device; and
a display unit configured to control the light-emitting sub-pixels to emit light according to assigned pixel gray values, so that the display device displays a multi-viewpoint image corresponding to the source image.

18. A display apparatus, comprising a display device and the driving device for the display device according to claim 17.

19. A computing and processing apparatus, comprising:
a memory, wherein a computer-readable code is stored in the memory; and
one or more processors, wherein when the computer-readable code is executed by the one or more processors, the computing and processing apparatus executes the driving method for the display device according to claim 1.

20. (canceled)

21. A non-transitory computer-readable medium, wherein the computer-readable medium stores a computer-readable code, the computer-readable code, when running on a computing and processing apparatus, causes the computing and processing apparatus to execute the driving method for the display device according to claim 1.
